(19) United States
(12) Patent Application Publication
(10) Pub. No.: US 2007/0056888 A1
(43) Pub. Date: Mar. 15, 2007

(54) Filter change indicator

(76) Inventors: Michael J. Williams, Glastonbury, CT (US); David Ferreira, Glastonbury, CT (US); Stephen J. Vardion, Glastonbury, CT (US)

Correspondence Address: ALIX YALE & RISTAS LLP, 750 MAIN STREET, SUITE 1400, HARTFORD, CT, 06103, US

(21) Appl. No.: 11/518,294

(22) Filed: Sep. 8, 2006

Related U.S. Application Data
(60) Provisional application No. 60/715,770, filed on Sep. 9, 2005.

(51) Int. Cl. B01D 35/14

(52) U.S. Cl. 210/90; 210/94; 116/266; 116/272

(57) ABSTRACT

A filter change indicator includes two indicators visible through a window. The first indicator is disposed in the viewing window in a fixed position. The second indicator covers the first indicator in a first position and is moveable relative to the first indicator to a second position revealing the first indicator. The filter change indicator also includes a spring and flexible diaphragm arranged such that changes in the pressure of a fluid system moves the second indicator to expose the first indicator to provide a visual indication of filter occlusion.

### CROSS-REFERENCE TO RELATED APPLICATION

This application claims the benefit under 35 U.S.C. § 119(e) of U.S. Provisional Application No. 60/715,770, filed Sep. 09, 2005, the contents of which are incorporated herein by reference.

### BACKGROUND OF THE INVENTION

1. Field of the Invention

The present invention relates to fluid systems having a filtration device in which restriction of the filtration device can be determined by measurement of pressure. More specifically, the invention relates to devices for indicating whether a fluid filter requires replacement.

2. Description of the Related Prior Art

Fluid systems requiring filtration apparatus are an integral part of the automotive and heavy equipment industries. Engine systems, hydraulic systems and various other collateral systems require fluids such as air, oil, fuel and coolants to be at least partially contained and directed to their functional end points. For instance, in engine systems utilizing diesel fuel, extremely high-pressure pumps are utilized. These pumps have very close tolerances and may be easily damaged or disabled by particulate laden fuel. In addition, the fuel injectors of these engines are configured to deliver a spray of fuel in a specifically designed pattern. Interference with the passages, orifices or other structures of the injectors may result in a decrease in engine efficiency and/or damage to the engine itself. Most of the above-described fluid systems, including most diesel fuel systems, require at least one filter to be present.

In diesel fuel systems, a primary fuel filter is arranged between the fuel storage compartment and the high-pressure fuel pump. Fuel delivery systems for diesel engines typically include a fuel supply pump for delivery of partially pressurized fuel to the high-pressure pump. These fuel supply pumps can be arranged in the fuel storage compartment or close to the high-pressure pump. When arranged in the fuel storage compartment, the supply pump pressurizes the fuel supply line leading to the high-pressure pump. When arranged close to or as part of the high-pressure pump, the supply pump creates negative pressure in the supply line between the fuel storage compartment and the supply pump.

Depending on such things as preventative maintenance scheduling, fluid quality, operating conditions and the like, filters become restricted or clogged at various rates. Filter occlusion may adversely impact system efficiency and in some cases may damage or destroy system components. In other cases restriction of the filter can result in filter failure which may allow highly contaminated fluid to reach portions of a high pressure pump or fuel injection system, resulting in extremely high repair costs for those devices.

### BRIEF DESCRIPTION OF THE DRAWINGS

FIG. 1 is a sectional view through an embodiment of the filter change indicator according to aspects of the present invention; and

FIGS. 2-4 are sectional views of a filter assembly incorporating the filter change indicator of FIG. 1 indicating various filter life conditions.

### DETAILED DESCRIPTION OF THE PREFERRED EMBODIMENT

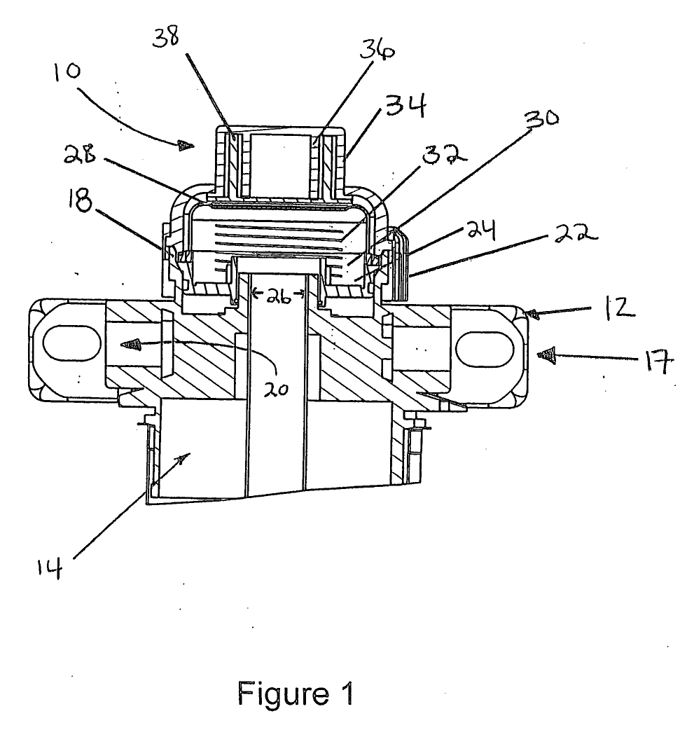

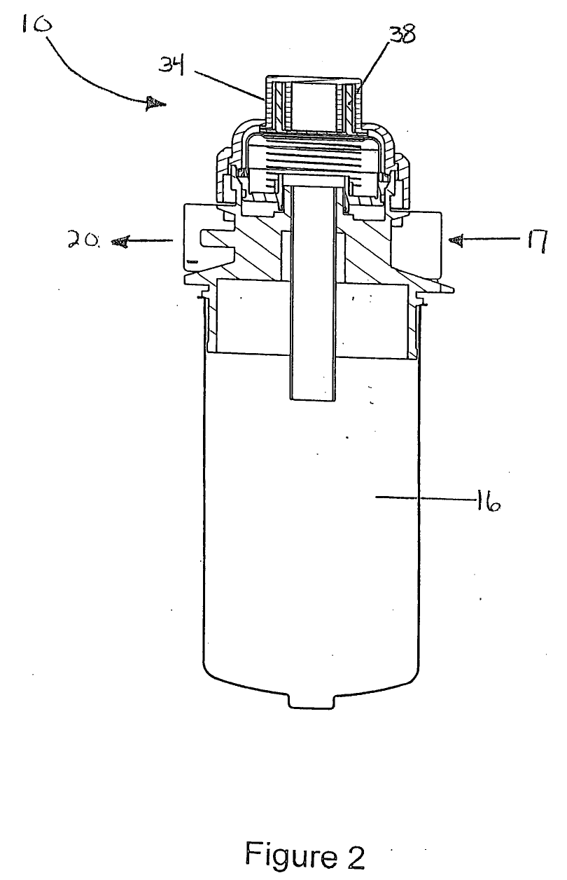

An embodiment of a filter change indicator according to aspects of the present invention will now be described with reference to FIGS. 1-4 wherein like reference numerals refer to similar parts. A filter change indicator 10 according to aspects of the present invention is configured for mounting to the base 12 of a filter assembly. The base 12 is configured to define fluid inlet and outlet passages delivering fluid into and away from a received filter cartridge as is known in the art. The base 12 defines a cartridge receptacle 14 for receiving a removable disposable filter cartridge 16 as shown in FIGS. 2-4. The filter cartridge 16 is typically a housing surrounding a filter element (not shown). The filter cartridge includes internal conduits, baffles, grommets and the like (also not shown) that permit fluid circulation between a fluid inlet 17 and fluid outlet 20 only through the filter element.

The base 12 includes an axial upwardly extending threaded lip 18 defining an opening that communicates with the fluid outlet passage 20. A collar 22 engages the threaded lip 18 to retain the filter change indicator 10 to the base. As best seen in FIG. 1, the filter change indicator 10 includes a spring perch 24 surrounding the axial opening 26 into the fluid outlet 20 and defining a spring seat. A flexible diaphragm 28 is sealingly compressed against the periphery of the spring perch 24 by the collar 22 to define a sealed variable volume chamber 30 communicating with the fluid outlet 20. A spring 32 is compressed between the spring perch 24 and an inside surface of the diaphragm 28, biasing the diaphragm toward an upwardly extended position.

The collar 22 extends upwardly and inwardly to define an axial opening through which projects an indicator housing 34 through which the relative positions of two co-axial indicator sleeves 36, 38 can be observed. The inner indicator sleeve 36 is fixed to the indicator housing 34, while the outer indicator sleeve 38 is arranged to move with the diaphragm 28.

It should be noted that the filter change indicator 10 of the present invention is configured for use in a fuel filter assembly positioned between the fuel supply and the supply pump. In such a suction arrangement, an occluded filter generates an increased negative pressure at the fuel outlet 20 of the filter assembly. It is the magnitude of this negative pressure to which the present fuel change indicator is responsive.

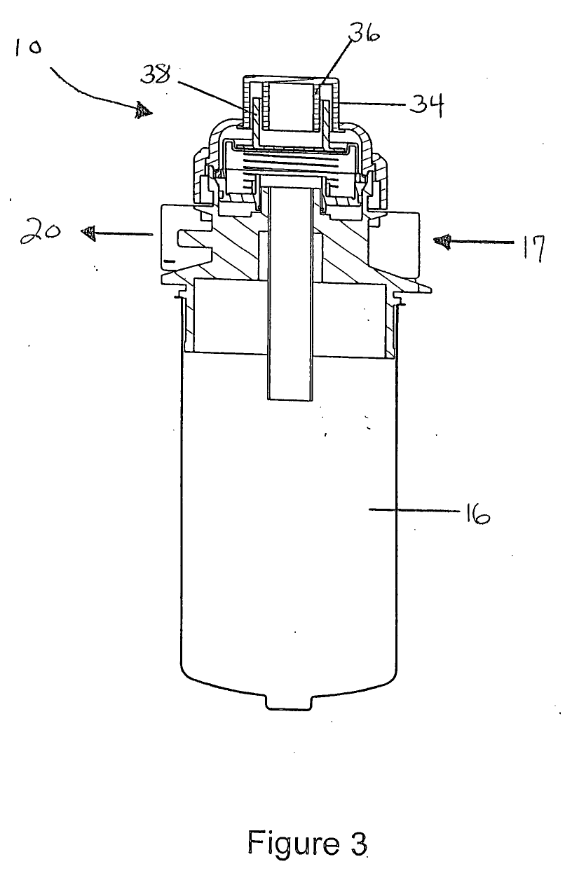

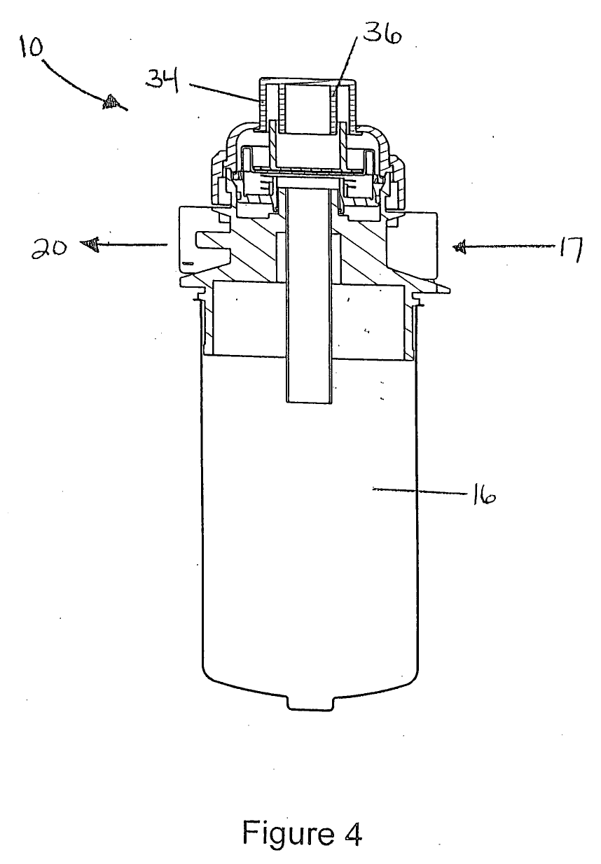

In the context of the present invention, the inner fixed indicator sleeve 36 is red, and the outer movable indicator sleeve 38 is green. Other contrasting colors or shades such as black and white are also possible. The spring 32 and diaphragm 28 are selected such that a predefined, relatively low negative pressure at the fuel outlet 20 of the filter assembly (indicative of relatively free flow between the fluid inlet and outlet 17, 20) is insufficient to compress the spring 32 and collapse the diaphragm 28. In this condition, the green outer indicator sleeve 38 will remain in its upwardly biased position (as shown in FIGS. 1 and 2), indicating that the cartridge mounted to the assembly is relatively new and unobstructed. As the filter element becomes occluded by particulate matter removed from the fluid flow, the absolute value of the negative pressure at the fluid outlet of the filter assembly increases, acting on the diaphragm to compress the spring and move the outer green indicator sleeve 38 downwardly as shown in FIGS. 3 and 4.

Downward movement of the green outer indicator sleeve 38 exposes the red inner indicator sleeve 36. This relative movement of the green and red indicator sleeves 36, 38 exposes more and more of the red indicator sleeve 36 as the negative pressure at the fluid outlet increases. Ultimately, the negative pressure is such that the spring 32 and diaphragm 28 are collapsed and the green indicator sleeve 38 is moved to entirely expose the red indicator sleeve 36. This condition is a readily recognizable indication that the filter element is substantially occluded and requires changing.

The filter change indicator 10 is illustrated as attached to the base 12 of a filter assembly in a vertical position. This location and orientation are not necessary to the invention. Embodiments of a filter change indicator could be positioned anywhere the sealed chamber 30 communicates with the fuel delivery path between the filter 16 and the supply pump (not shown). The filter change indicator 10 is responsive to increases in negative pressure. The initial low value of the negative pressure where the components are in position illustrated in FIGS. 1 and 2 corresponds to approximately 1″ to 2″ of mercury. The components are selected such that the filter is considered occluded and changes indicated as shown in FIG. 4 correspond to a negative pressure of approximately 7″ to 10″ of mercury.

Hand primers for filter assemblies are illustrated in U.S. Pat. Nos. 6,019,890 and 5,578,221, the contents of which are hereby incorporated by reference. The filter change indicator may be combined with a suitable hand primer in a single assembly. A hand knob or plunger would be arranged to pass through the inner and outer sleeves 36, 38 to manually compress the spring 32 and diaphragm 28, thereby forcing fuel into the outlet 20. A one way valve (not shown) would allow the expanding spring and diaphragm to draw more fuel in from the inlet 17. Repeating the manual compression and release of the spring and diaphragm primes the supply pump with fuel as is known in the art.

What is claimed is:

1. A negative pressure visual indicator comprising:
a sealed chamber at least partially defined by a flexible diaphragm in communication with a fluid flow path, the negative pressure of which is to be detected;
a housing surrounding said chamber and including an axially extending window portion through which visual indications are apparent;
a first indicator sleeve extending into said window portion and attached to said housing in a fixed position;
a second indicator sleeve coaxial with and slideably moveable relative to said first indicator sleeve, said second indicator sleeve arranged for movement in conjunction with said diaphragm; and
a spring arranged in said sealed chamber to bias said diaphragm toward said window portion,
wherein said spring and diaphragm are configured such that a predetermined increase in negative pressure in said fluid flow pathway acts to move said second indicator sleeve away from said first indicator sleeve.

2. The pressure indicator of claim 1 wherein said bias of said spring causes said second indicator sleeve to extend into said window and block said first indicator sleeve from view.

3. The pressure indicator of claim 2 wherein the movement of said spring and said diaphragm in response to said predetermined increase in negative pressure causes said second indicator sleeve to reveal at least a portion of said first indicator sleeve through said window portion.

4. The pressure indicator of claim 1 wherein said first and second indicator sleeves are colored.

5. The pressure indicator of claim 4 wherein said first indicator sleeve is red and said second indicator sleeve is green.

6. A fluid system/pressure indicator combination comprising:
a fluid system having a fluid flow pathway extending between a filter element and a fluid pump, said fluid pump arranged to draw fluid through said filter element;
a filter base including an inlet connected to a fluid source and an outlet in communication with said fluid flow pathway, said base portion defining a cartridge receptacle configured to receive a removable filter cartridge;
a pressure indicator secured to said filter base, said pressure indicator defining a viewing window and comprising:
a first visual indicator disposed in said viewing window in a fixed position;
a second visual indicator configured to overlap said first visual indicator in said viewing window;
a flexible diaphragm connected to said second visual indicator and exposed to said fluid flow pathway;
a spring arranged to bias said diaphragm and second visual indicator toward a position covering said first visual indicator;
a filter cartridge received in said cartridge receptacle and fluidly connected between said inlet and outlet, said cartridge comprising a cartridge housing surrounding said filter element and constructed to permit fluid circulation between said inlet and outlet only through said filter element;
wherein said diaphragm and second visual indicator move to uncover said first visual indicator in response to a predetermined increase in negative pressure in said fluid flow pathway, thereby providing a visual indication of the condition of said filter element.

7. The fluid system/pressure indicator combination of claim 6, wherein said viewing window, first and second visual indicators are cylindrical and substantially coaxial.

8. The fluid system/pressure indicator combination of claim 6, wherein said diaphragm at least partially defines a chamber, the volume of which chamber changes in response to changes in negative pressure in said fluid flow path in excess of a predetermined level.

9. The fluid system/pressure indicator combination of claim 6, wherein the diaphragm is configured to axially displace said second visual indicator in response to a predetermined pressure change in said fluid flow pathway.

10. The fluid system/pressure indicator combination of claim 6, further including an integrated hand primer adapted for manually compressing said spring and said diaphragm whereby fluid is pumped into said fluid flow path.

11. The fluid system/pressure indicator combination of claim 6, wherein said first visual indicator is covered by said second visual indicator until said second pressure communicator is axially displaced.

12. The fluid system/pressure indicator combination of claim 6, wherein said first and second visual indicators are of contrasting pigmentation.

13. A negative pressure visual indicator comprising a sealed chamber at least partially defined by a flexible diaphragm in communication with a fluid flow path, the negative pressure of which is to be detected;
a housing surrounding said chamber and including a window through which visual indications are apparent;
a first indicator sleeve fixed with respect to said housing;
a second indicator sleeve coaxial with and surrounding said first indicator sleeve, said second indicator sleeve arranged for movement with said diaphragm relative to said housing; and
a spring arranged in said sealed chamber to bias said diaphragm and second indicator sleeve toward a position in which said second indicator sleeve covers said first indicator sleeve,
wherein said spring and diaphragm are selected such that predetermined increases in negative pressure in said fluid flow pathway act to compress said spring and collapse said diaphragm, thereby moving said second indicator sleeve to expose said first indicator sleeve and provide a visual indication of said predetermined increase in negative pressure.
